(19) United States
(12) Patent Application Publication
(10) Pub. No.: US 2008/0003992 A1
(43) Pub. Date: Jan. 3, 2008

(54) MANAGEMENT OF CONCURRENT NETWORK LINKS ON A WIRELESS COMMUNICATION DEVICE

(75) Inventors: Roberto Gautier, Davie, FL (US); Daniel A. Baudino, Lake Worth, FL (US); James R. Wise, Monroe, NC (US); Jason T. Young, Palm City, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/427,338

(22) Filed: Jun. 28, 2006

(51) Int. Cl. H04M 3/00

(52) U.S. Cl. 455/418

(57) ABSTRACT

A user interface (720) that presents a plurality of screens and a communication device (700) that includes such a user interface. The plurality of screens can include a first screen (102) that indicates a first communication link is established between the communication device and a first contact, and a second screen (114) that indicates at least a second contact with which the communication device is to establish a second communication link. A third screen (140) also can be provided. The third screen can indicate that the first communication link is established and the second communication link is established, and present at least one selectable item (144) correlating to the first communication link and at least one selectable item (146) correlating to the second communication link.

### BACKGROUND OF THE INVENTION

1. Field of the Invention

The present invention generally relates to communication devices and, more particularly, to wireless communication devices that use multiple network links.

2. Background of the Invention

Mobile stations sometimes include more than one mode of communication. Such mobile stations may include transceivers that are capable of communicating with an interconnect communications network and communicating with a dispatch communications network. The ability to use multiple communication modes can be very beneficial. For instance, the dispatch network can be used to quickly establish communication links with other dispatch network users, and the interconnect communications network can be used to establish communication links with users who do not subscribe to the dispatch network. Implementation of multiple communication modes and additional features to support multiple communication modes adds complexity to the user experience, however.

### SUMMARY OF THE INVENTION

The present invention relates to a user interface that presents a plurality of screens. The present invention also relates to a communication device that includes such a user interface. The plurality of screens can include a first screen that indicates a first communication link is established between the communication device and a first contact, and a second screen that indicates at least a second contact with which the communication device is to establish a second communication link. One of the communication links can be a dispatch call and one of the communication links can be an interconnect call. In another arrangement, one of the communication links can be a dispatch call and one of the communication links can be a data session. In yet another arrangement, one of the communication links can be an interconnect call and one of the communication links can be a data session.

A third screen also can be provided. The third screen can indicate that the first communication link is established and the second communication link is established, and present at least one selectable item correlating to the first communication link and at least one selectable item correlating to the second communication link. The selectable items correlating to the first communication link can include a first selectable item that, when selected, mutes the first communication link, and a second selectable item that, when selected, ends the first communication link. The selectable items correlating to the second communication link can include a third selectable item that, when selected, mutes the second communication link, and a fourth selectable item that, when selected, ends the second communication link. The third screen also can present a selectable item that, when selected, links the first communication link and the second communications link.

The plurality of screens further can include a fourth screen that presents a selectable item that, when selected, unlinks the first communication link and the second communication link. In another arrangement, the fourth screen can present a selectable item that, when selected, enters the communication device into a mode in which the communication device is a hub for the first communication link and the second communications link. In such an arrangement, the plurality of screens further can include a fifth screen that presents a selectable item that, when selected, disables the mode in which the communication device is the hub for the first communication link and the second communications link. In yet another arrangement, the fourth screen can present a selectable item that, when selected, blocks the first communication link or the second communication link.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIGS. 1A and 1B collectively present a menu flow diagram that is useful for understanding the present invention;

FIG. 2 is another menu flow diagram that is useful for understanding the present invention;

FIG. 3 is another menu flow diagram that is useful for understanding the present invention;

FIG. 4 is another menu flow diagram that is useful for understanding the present invention;

FIG. 5 is another menu flow diagram that is useful for understanding the present invention;

FIG. 6 is another menu flow diagram that is useful for understanding the present invention; and

FIG. 7 depicts a block diagram of a communication device that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for controlling a plurality of concurrent communication links established by a communication device. The method can be implemented with a user interface that presents a plurality of screens comprising user selectable items associated with the communication links. The user selectable items can be selected to establish the communication links, enable communication between a plurality of the communication links, mute one or more of the communication links, disconnect one or more of the communication links, or initiate control functions on the communication device.

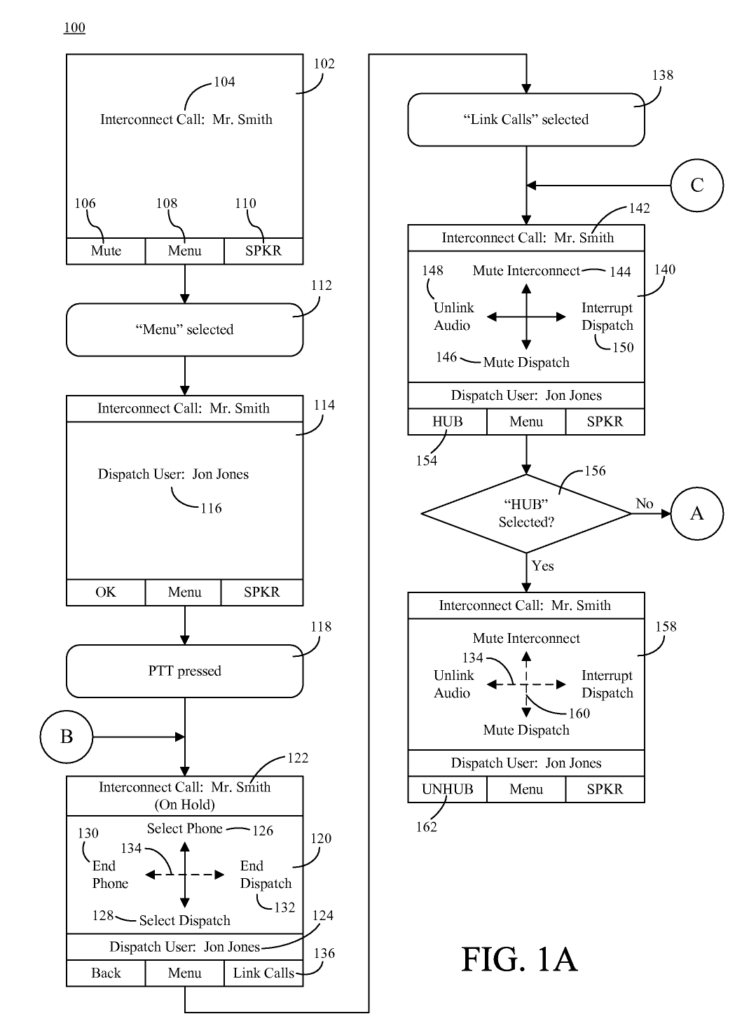

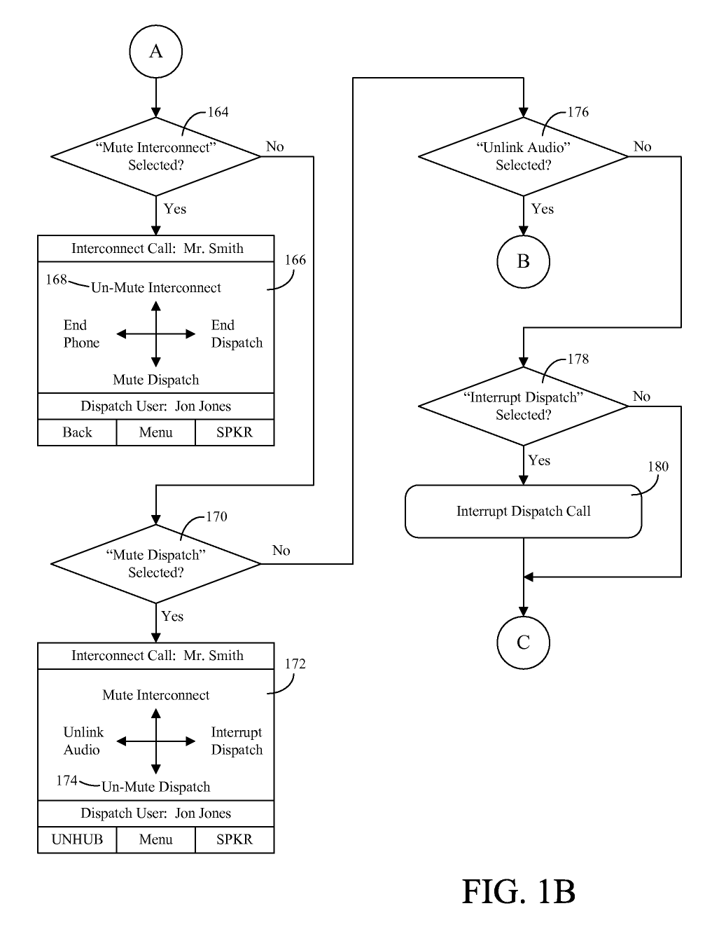

FIGS. 1-6 present menu flow diagrams which depict screens that can be presented by a user interface of the communication device in accordance with the inventive arrangements described herein. In the screens, user selectable items are presented which, when selected, signal the communication device to perform functions correlating to the user selectable items. In the examples presented herein, the user selectable items and other indicators are depicted as text. Notwithstanding, the user selectable items and indicators can be embodied as icons, buttons, keys, soft keys or in any other suitable manner. Moreover, the user selectable items can be selected by navigating to such items using navigation keys, a navigation pod, depressing associated buttons, depressing associated keys, depressing associated soft keys, uttering one or more commands detectable by the communication device and/or performing any other suitable actions.

FIGS. 1A and 1B collectively present a menu flow diagram 100 that is useful for understanding the present invention. The menu flow diagram 100 can begin in a state in which a first communication link for an interconnect call has been established on a communication device. Referring to screen 102, an indicator 104 can be presented to indicate that the communication link is established. In addition, a plurality of user selectable items can be presented, for instance “Mute” 106, “Menu” 108 and “SPKR” 110. “Mute” 106 can be selected to mute the interconnect call and “SPKR” 110 can be selected to enter the communication device into a hands-free mode.

At step 112, “Menu” 108 can be selected and a menu (not shown) which provides an option to establish a second communication link can be presented. In response to such option being selected, a screen 114 can be presented. The screen 114 can include a user selectable item 116 to establish a second communication link on the communication device. For example, the user selectable item 116 can provide an option to establish a dispatch call.

At step 118, a push-to-talk (PTT) button can be depressed to initiate the dispatch call. In response, the interconnect call can be placed on hold and a screen 120 can be presented. An indicator 122 can indicate that the communication link for the interconnect call is maintained, but that the interconnect call is on hold. An indicator 124 can be presented to indicate that the dispatch call is active. In addition, a plurality of user selectable items can be presented for controlling the communication links. For example, “Select Phone” 126, “Select Dispatch” 128, “End Phone” 130 and “End Dispatch” 132 can be presented. “Select Phone” 126 can be selected to take the interconnect call off hold and make the interconnect call active. “Select Dispatch” 128 can be selected to make the dispatch call active and place the interconnect call on hold. The functionality of “End Phone” 130 and “End Dispatch” 132 can remain deactivated until the interconnect call and the dispatch call are linked, as will be described. To indicate the deactivated status, “End Phone” 130 and “End Dispatch” 132 can be presented in a font, color, shading or ghosting that indicates such status. Other associated symbols, such as a line 134 also can be presented in a manner to indicate the status.

The screen 120 also can include a “Link Calls” 136 user selectable item, which can be selected at step 138. In response, the communication device can enter a mode in which the interconnect call and the dispatch call are linked. In addition, a screen 140 can be presented. In the screen 140, an indicator 142 can be presented to indicate that the interconnect call is off hold. Further, “Mute Interconnect” 144, “Mute Dispatch” 146, “Unlink Audio” 148 and “Interrupt Dispatch” 150 user selectable items can be presented. In addition, a “HUB” 154 user selectable item can be presented.

Referring to decision box 156, if “HUB” 154 is selected, the communication device can enter a hub mode and a screen 158 can be presented. In the hub mode, communication between the interconnect call and the dispatch call can be maintained, although the communication device can function passively in the sense that it does not add audio data to communication signals exchanged between the interconnect call and the dispatch call. To indicate the passive status, “Mute Interconnect” 144, “Mute Dispatch” 146, “Unlink Audio” 148 and “Interrupt Dispatch” 150 can be presented in a font, color, shading or ghosting that indicates such status. The line 134 and a line 160 also can be presented in a manner to indicate the status. An “UNHUB” 162 user selectable item can be selected at any time to disable the hub mode and actively engage the communication device with the interconnect call and the dispatch call, and the screen 140 can again be presented.

Referring again to decision box 156, if “HUB” 154 was not selected, the menu flow diagram can proceed to decision box 164 in FIG. 1B. If “Mute Interconnect” 144 is selected in screen 140, the Interconnect call can be muted and a screen 166 can be presented in which “Mute Interconnect” 144 is changed to an “Un-Mute Interconnect” 168 user selectable item. “Un-Mute Interconnect” 168 can be selected when it is desired to un-mute the interconnect call, in which case the screen 140 can again be presented.

If “Mute Interconnect” 144 is not selected, the process can proceed to decision box 170. If “Mute Dispatch” 146 is selected in screen 140, the dispatch call can be muted and a screen 172 can be presented in which “Mute Dispatch” 146 is changed to an “Un-Mute Dispatch” 174 user selectable item. “Un-Mute Dispatch” 174 can be selected when it is desired to un-mute the dispatch call, in which case the screen 140 can again be presented.

Proceeding to decision box 176, if “Unlink Audio” 148 is selected, the communication device can enter a mode in which the dispatch and interconnect calls are unlinked. In one arrangement, the call that was previously on hold before the calls were linked, which in this example is the interconnect call, can again be placed on hold. The screen 120 then can be presented. In another arrangement, the call that was not previously on hold can be the call that is placed on hold after the calls are unlinked. In yet another arrangement, the user can be prompted to select which call to place on hold.

Referring to decision box 178, if “Interrupt Dispatch” 150 is selected, at step 180 the dispatch call can be interrupted and the screen 140 can continue to be displayed.

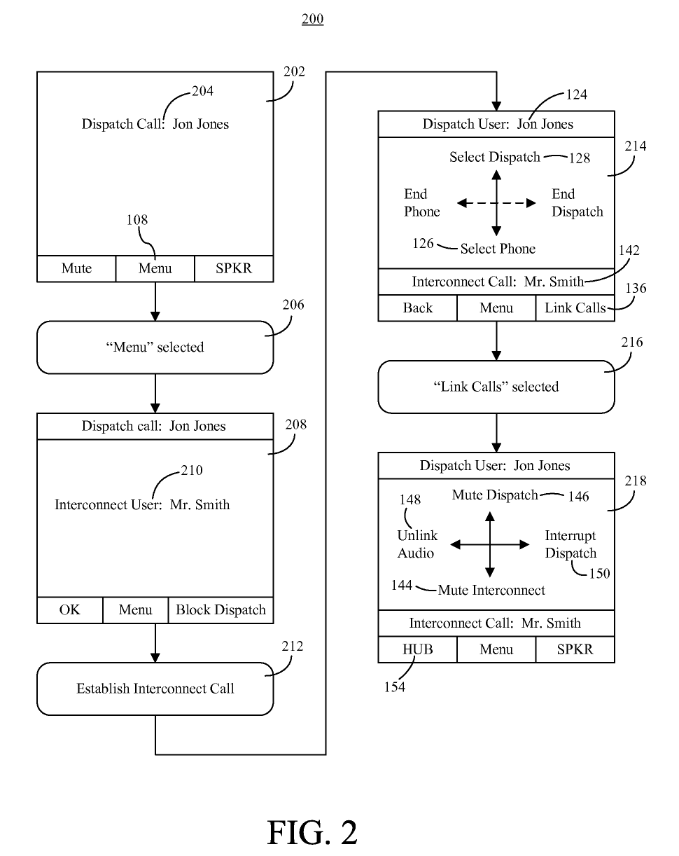

FIG. 2 is another menu flow diagram 200 that is useful for understanding the present invention. The menu flow diagram 200 can begin in a state in which a first communication link for a dispatch call has been established on a communication device. Referring to screen 202, an indicator 204 can be presented to indicate that the communication link is established. At step 206, “Menu” 108 can be selected and a menu (not shown) which provides an option to establish a second communication link can be presented. In response to such option being selected, a screen 208 can be presented. The screen 208 can include a user selectable item 210 to establish a second communication link on the communication device. For example, the user selectable item 210 can provide an option to establish an interconnect call.

At step 212 the interconnect call can be established. A screen 214 then can be presented. The indicator 124 can indicate that the communication link for the dispatch call is maintained, and the indicator 142 can be presented to indicate that the interconnect call is active. Because the dispatch call was established prior to the interconnect call, in contrast to screen 140 of FIG. 1, the relative positions of the indicator 124 and the indicator 142 can be changed. In addition, in contrast to screen 120 of FIG. 1, the relative positions of “Select Phone” 126 and “Select Dispatch” 128 can be changed to correspond to the relative locations of the respective indicators 124, 142.

At step 216, “Link Calls” 136 can be selected to link the dispatch call and the interconnect call. In addition, a screen 218 can be presented. User selectable items presented in screen 218, such as “Mute Interconnect 144, “Mute Dispatch” 146, “Unlink Audio” 148, “Interrupt Dispatch” 150 and “HUB” 154 can provide functionality previously discussed in FIG. 1.

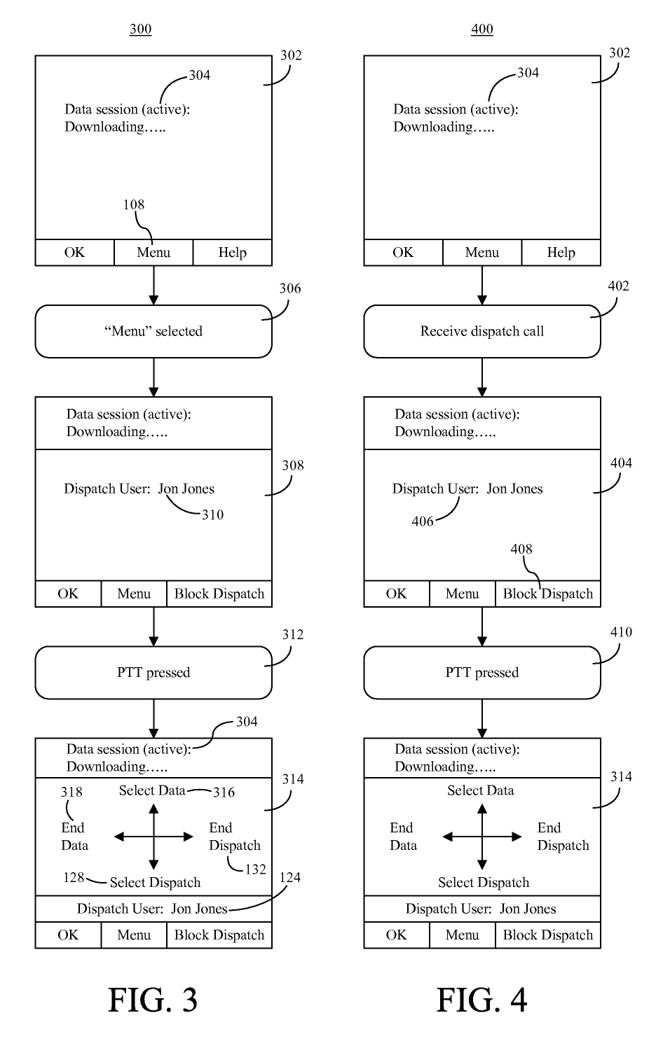

FIG. 3 is another menu flow diagram 300 that is useful for understanding the present invention. The menu flow diagram 300 can begin in a state in which a first communication link for a data session has been established on a communication device. Referring to screen 302, an indicator 304 can be presented to indicate that the communication link is established. At step 306, “Menu” 108 can be selected and a menu (not shown) which provides an option to establish a second communication link can be presented. In response to such option being selected, a screen 308 can be presented. The screen 308 can include a user selectable item 310 to establish a second communication link on the communication device. For example, the user selectable item 310 can provide an option to establish a dispatch call.

At step 312 a PTT button can be depressed to initiate the dispatch call and a screen 314 can be presented. Meanwhile, the data session can be maintained, which can be indicated by the indicator 304. In addition, the indicator 124 can be presented to indicate that the dispatch call is active. A “Select Data” 316 user selectable item can be presented and can be mapped to functions on the communication device pertaining to the data session. An “End Data” 318 user selectable option can be presented. “End Data” 318 can be selected by a user to end the data session. Further, “Select Dispatch” 128 and “End Dispatch” 132 can be presented and selected to perform the associated functions previously described.

FIG. 4 is another menu flow diagram 400 that is useful for understanding the present invention. The menu flow diagram 400 also can begin in a state in which a first communication link for a data session has been established on a communication device. Referring to screen 302, an indicator 304 can be presented to indicate that the communication link is established. At step 402 a dispatch call can be received. In response, a screen 404 can be presented. The screen 404 can include an indicator 406 that indicates the dispatch user who is placing the dispatch call. A user of the communication device can select a “Block Dispatch” 408 user selectable option to block the dispatch call, in which case screen 302 can again be presented. Alternatively, at step 410 the user can press the PTT button to establish the dispatch communication link. In response to the PTT button being depressed, the screen 314 can be presented.

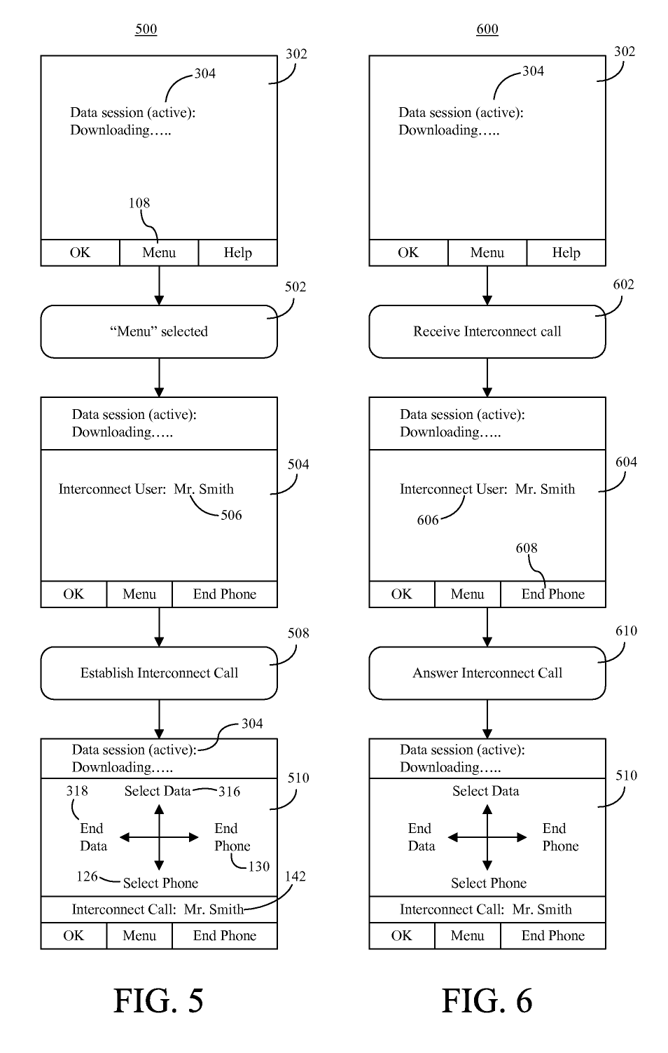

FIG. 5 is another menu flow diagram 500 that is useful for understanding the present invention. The menu flow diagram 500 also can begin in a state in which a first communication link for a data session has been established on a communication device. Referring to screen 302, the indicator 304 can be presented to indicate that the communication link is established. At step 502, “Menu” 108 can be selected and a menu (not shown) which provides an option to establish a second communication link can be presented. In response to such option being selected, a screen 504 can be presented. The screen 504 can include a user selectable item 506 to establish a second communication link on the communication device. For example, the user selectable item 506 can provide an option to establish an interconnect call.

At step 508 the interconnect call can be established. Meanwhile, the data session can be maintained and a screen 510 can be presented. The indicator 304 can indicate that the communication link for the data session is maintained, and the indicator 142 can be presented to indicate that the interconnect call is active. “Select Data” 316, “End Data” 318, “Select Phone” 126 and “End Phone” 130 can be presented and selected to perform the associated functions previously described.

FIG. 6 is another menu flow diagram 600 that is useful for understanding the present invention. The menu flow diagram 600 also can begin in a state in which a first communication link for a data session has been established on a communication device. Referring to screen 302, the indicator 304 can be presented to indicate that the communication link is established. At step 602 an interconnect call can be received. In response, a screen 604 can be presented. The screen 604 can include an indicator 606 that indicates the interconnect user who is placing the interconnect call. A user of the communication device can select an “End Phone” 608 user selectable option to terminate the interconnect call, in which case screen 302 can again be presented. Alternatively, at step 610 the user can answer the interconnect call, for example by using a navigation key, a navigation pod, depressing a button, depressing a key, depressing a soft keys, uttering one or more commands detectable by the communication device and/or performing any other suitable action. In response to the interconnect call being answered, the screen 510 can be presented. Meanwhile, the data session can be maintained.

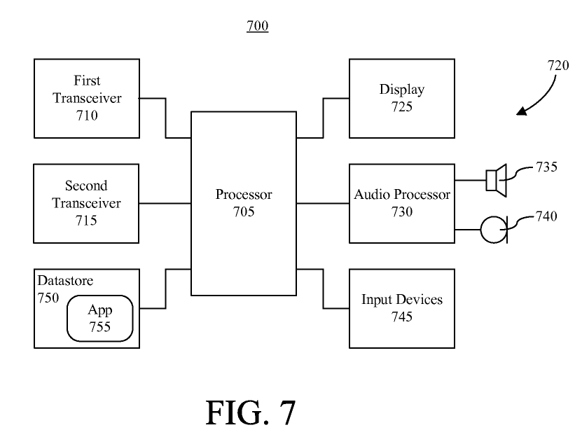

FIG. 7 depicts a block diagram of a communication device 700 that is useful for understanding the present invention. The communication device 700 can be an electronic apparatus, such as a mobile station. Examples of mobile stations include mobile telephones, mobile computers, personal digital assistants, and the like. Nonetheless, the invention is not limited in this regard and communication device can be any device capable of establishing a plurality of concurrent communication links.

The communication device 700 can include one or more processors 705. The processor(s) 705 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The communication device 700 also can include a first transceiver 710. The first transceiver 710 can communicate information via IEEE 802 wireless communications, WPA, WPA2, GSM, TDMA, CDMA, WCDMA, direct wireless communication, TCP/IP, or any other suitable form of mobile communications. Optionally, a second transceiver 715 can be provided. The second transceiver also can communicate via IEEE 802 wireless communications, WPA, WPA2, GSM, TDMA, CDMA, WCDMA, direct wireless communication, TCP/IP, or any other suitable form of mobile communications. The communication device 700 can establish a first communication link, for example an interconnect call, using the first transceiver 710. The communication device 700 also can establish a second communication link, for example a dispatch call, using the first transceiver 710. In another arrangement, the second communication link can be established using the second transceiver 715.

The communication device 700 also can include a user interface 720. The user interface 720 can include a display 725 for presenting the screens described herein. The display 725 can be a liquid crystal display (LCD), a liquid crystal on silicon (LCOS) display, a plasma display, a segmented display, a cathode ray tube (CRT), or any other display suitable for presenting user selectable items described herein.

The user interface also can include an audio processor 730 operatively coupled to an output audio transducer 735 (e.g. loudspeaker) and an input audio transducer 740 (e.g. microphone). The audio processor 730 can be integrated with the processor 705, or provided as a separate component that is communicatively linked to the processor 705. The audio processor 730 can comprise a CPU, a DSP, an ASIC, a PLD, a plurality of discrete components that cooperate to process audio data, and/or any other suitable audio processing device.

One or more additional input devices 745 can be provided. Examples of such input devices can include keys, soft keys, navigation pods, buttons, navigation buttons, and the like. In one arrangement, the display 725 can include a touch screen that is used as an input device in addition to, or in lieu of, the input devices 745.

The communication device 700 also can include a datastore 750 on which a communications application 755 is stored. The datastore 750 can include a magnetic storage medium, an electronic storage medium, an optical storage medium, a magneto-optical storage medium, or any other storage medium suitable for storing digital information. In one arrangement, the datastore 750 can be integrated into the processor 705.

The communications application 755 can be executed by the processor 705 to implement the processes disclosed herein. For example, the processor 705 can communicate with the first transceiver 710 to establish the first communication link. The processor 705 also can communicate with the first transceiver 710 or the second transceiver 715 to establish the second communications link. Further, the processor 705 can establish an inter-processor communication link between the first and second communications links, for example when a user has selected to link the first and second communication links. The inter-processor communication link can be implemented as a process which passes data from the first transceiver 710 to the second transceiver 715, and from the second transceiver 715 to the first transceiver 710. Such passing of data can be accomplished using methods known in the art. One example of such a method can use dual port random access memory that is accessible by both transceivers 710, 715, but other techniques can be used and the invention is not limited in this regard.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A user interface that presents a plurality of screens, the plurality of screens comprising:
a first screen that indicates a first communication link is established between a communication device and a first contact;
a second screen that indicates at least a second contact with which the communication device is to establish a second communication link; and
a third screen that indicates that the first communication link is established and the second communication link is established, and presents at least one selectable item correlating to the first communication link and at least one selectable item correlating to the second communication link.

2. The user interface of claim 1, wherein the at least one selectable item correlating to the first communication link comprises:
a first selectable item that, when selected, mutes the first communication link; and
a second selectable item that, when selected, ends the first communication link.

3. The user interface of claim 1, wherein the at least one selectable item correlating to the second communication link comprises:
a third selectable item that, when selected, mutes the second communication link; and
a fourth selectable item that, when selected, ends the second communication link.

4. The user interface of claim 1, wherein the third screen presents a selectable item that, when selected, links the first communication link and the second communications link.

5. The user interface of claim 4, wherein the plurality of screens further comprises a fourth screen that presents a selectable item that, when selected, unlinks the first communication link and the second communication link.

6. The user interface of claim 1, wherein the plurality of screens further comprises a fourth screen that presents a selectable item that, when selected, enters the communication device into a mode in which the communication device is a hub for the first communication link and the second communications link.

7. The user interface of claim 6, wherein the plurality of screens further comprises a fifth screen that presents a selectable item that, when selected, disables the mode in which the communication device is the hub for the first communication link and the second communications link.

8. The user interface of claim 1, wherein the plurality of screens further comprises a fourth screen that presents a selectable item that, when selected, blocks at least one communication link selected from the group consisting of the first communication link and the second communication link.

9. The user interface of claim 1, wherein one communication link selected from the first communication link and the second communication link is a dispatch call and one communication link selected from the first communication link and the second communication link is an interconnect call.

10. The user interface of claim 1, wherein one communication link selected from the first communication link and the second communication link is a dispatch call and one communication link selected from the first communication link and the second communication link is a data session.

11. The user interface of claim 1, wherein one communication link selected from the first communication link and the second communication link is an interconnect call and one communication link selected from the first communication link and the second communication link is a data session.

12. A communication device comprising a user interface, the user interface presenting a plurality of screens comprising:
a first screen that indicates a first communication link is established between the communication device and a first contact;
a second screen that indicates at least a second contact with which the communication device is to establish a second communication link; and
a third screen that indicates that the first communication link is established and the second communication link is established, and presents at least one selectable item correlating to the first communication link and at least one selectable item correlating to the second communication link.

13. The communication device of claim 12, wherein the at least one selectable item correlating to the first communication link comprises:
a first selectable item that, when selected, mutes the first communication link; and
a second selectable item that, when selected, ends the first communication link.

14. The communication device of claim 12, wherein the at least one selectable item correlating to the second communication link comprises:
a third selectable item that, when selected, mutes the second communication link; and
a fourth selectable item that, when selected, ends the second communication link.

15. The communication device of claim 12, wherein the third screen presents a selectable item that, when selected, enters the communication device into a mode in which the communication device links the first communication link and the second communications link.

16. The communication device of claim 12, wherein the user interface further comprises a fourth screen that presents a selectable item that, when selected, enters the communication device into a mode in which the communication device is a hub for the first communication link and the second communications link.

17. A machine readable storage, having stored thereon a computer program having a plurality of code sections comprising:
code for presenting a first screen that indicates a first communication link is established between a communication device and a first contact;
code for presenting a second screen that indicates at least a second contact with which the communication device is to establish a second communication link; and
code for presenting a third screen that indicates that the first communication link is established and the second communication link is established, and presents at least one selectable item correlating to the first communication link and at least one selectable item correlating to the second communication link.

18. The machine readable storage of claim 17, wherein the at least one selectable item correlating to the first communication link comprises:
a first selectable item that, when selected, mutes the first communication link; and
a second selectable item that, when selected, ends the first communication link.

19. The machine readable storage of claim 17, wherein the at least one selectable item correlating to the second communication link comprises:
a third selectable item that, when selected, mutes the second communication link; and
a fourth selectable item that, when selected, ends the second communication link.

20. The machine readable storage of claim 17, wherein the third screen presents a selectable item that, when selected, links the first communication link and the second communications link.
